(19) United States
(12) Patent Application Publication
(10) Pub. No.: US 2001/0036820 A1
(43) Pub. Date: Nov. 1, 2001

(54) Distributed buffer management in a high data rate wireless network

(76) Inventors: Mo-Han Fong, L' Orignal (CA); Geng Wu, Plano, TX (US)

Correspondence Address: Bruce E. Garlick, Garlick & Harrison, P.O. Box 691, Spicewood, TX, 78669, US

(21) Appl. No.: 09/833,864

(22) Filed: Apr. 12, 2001

Related U.S. Application Data
(60) Provisional application No. 60/196,349, filed on Apr. 12, 2000.

(51) Int. Cl. H04M 11/00

(52) U.S. Cl. 455/403; 455/422

(57) ABSTRACT

Cellular wireless network structure and operations service high data rate forward link transmissions for a mobile station (MS). A base station controller (BSC) determines an active set of base stations (BTSs) for servicing the MS. The BSC receives packetized data from a data network and places the data in a centralized buffer (C-RLP). The BTSs each support a distributed buffer (D-RLP). The BSC downloads a plurality of blocks of data from the C-RLP buffer to each of the D-RLP buffers in the BTSs. A serving BTS of the active set of BTSs transmits forward link data to the MS at any one time. Upon a successful receipt of a block of data, the MS transmits a confirmation to the serving BTS that it received a particular block of data. The serving BTS detects that it requires D-RLP refilling and the BSC downloads a next plurality of blocks of data to each BTS of the active set of BTSs.

### CROSS-REFERENCE To RELATED APPLICATION

The present application claims priority pursuant to 35 U.S.C. Sec 119(e) to U.S. Provisional Application Ser. No. 60/196,349, filed Apr. 12, 2000, which is hereby incorporated by reference in its entirety.

### BACKGROUND

1. Technical Field

The present invention relates generally to cellular wireless communication networks; and more particularly to the servicing of high data rate packetized data communications within such cellular wireless communication networks.

2. Related Art

Wireless networks are well known. Cellular wireless networks support wireless communication services in many populated areas of the world. While wireless networks were initially constructed to service voice circuit-switched voice communications, they are now called upon to support packet-switched data communications as well.

The transmission of packetized data communications within a wireless network places different demands on networks than does the transmission of voice communications. Voice communications require a sustained bandwidth with minimum signal-to-noise ratio (SNR) and continuity requirements. Data communications, on the other hand, typically are latency tolerant but have higher total throughput requirements. Conventional circuit-switched wireless networks were designed to support the well-known voice communication requirements. Thus, wireless networks (as well as conventional circuit switched telephone networks) have been adapted to service data communications, with such adaptation providing mixed results. Thus, future wired and wireless networks will likely be fully packet switched.

Because data communications typically require significantly more bandwidth on the forward link than on the reverse link, various standards have been promoted to provide for a high data rate forward link. For example, in the 3GPP standards body, the high data rate down link packet access (HSDPA) standard has been promulgated. This HSDPA standard is a UMTS evolution standard, which will be released sometime in 2001. Likewise, the 3GPP2 standards body has released various standards that support high data rate forward link transmissions. One such standard is referred to as the 1×EV-DO standard that provides for data only high data rate forward link transmissions as therein described.

While these high data rate forward link data transmission standards support high data rate on the forward wireless link, the supporting infrastructure does not include structure and operations that will support high data rate streaming. In such case, as a mobile station moves from serving base station to serving base station, discontinuity will arise within the wireless communication system infrastructure. This discontinuity is caused by alterations in the forward link data path.

Thus, there is a need in the art for improvements in the data path structure of wireless networks to support high data rate forward link transmissions to a mobile station.

### SUMMARY OF THE INVENTION

In order to overcome these shortcomings, among others, the present invention includes structure and operations to service high data rate forward link transmissions for a mobile station. When the wireless network first initiates servicing of the forward link transmissions, a base station controller and a plurality of base stations first interact with the mobile station to determine active set of base stations for servicing the mobile station. The base stations of the active set of base stations are selected based upon the signal strength and/or signal to noise ratio of transmissions provided by each of the base stations, as detected by the mobile station. The active set of base stations may also be determined based upon additional network limitations such as the loading level at each of the base stations. The active set of base stations changes dynamically as the mobile station moves around during a data communication session. In some cases, some of the described operations of the base station controller are performed by a services gateway switching node.

The base station controller couples to a data network, e.g., the Internet, via a packet data service node (PDSN), packet data function, media gateway, or another data network edge node. In one particular embodiment, the PDSN supports layer 3 three and higher protocol layers, e.g., PPP/IP, etc. In such case, the PDSN supports higher layer data buffers. The base station controller supports a centralized component of a link layer protocol, e.g., Centralized Radio Link Protocol (C-RLP). Further, the base stations of the active set each support a distributed component of the link layer protocol, e.g., Distributed Radio Link Protocol (D-RLP), and lower protocol layers, e.g., Media Access Control layer (MAC) and physical layer (PHY). These protocol layer components are substantially disclosed in the HSDPA standards and the 1×EV-DO standards, for example.

The C-RLP layer in the base station controller supports a C-RLP buffer (centralized buffer) and each of the base stations in the active set of base stations includes a D-RLP buffer (distributed buffer). The C-RLP layer receives forward link data intended for the mobile station, packages the forward link data into blocks of data, uniquely identifies the blocks of data with sequence numbers, and stores the blocks of data in the C-RLP buffer.

Throughput the data communication session between the mobile station and the wireless network, the active set of base stations is determined dynamically as the mobile station moves. Whenever one or more new base stations are added to the active set of base stations, the base station controller downloads to the newly added base stations a plurality of blocks of data from the C-RLP buffer, wherein each block of data of the plurality of blocks of data includes a respective sequence number, and wherein a first block of data of the plurality of blocks of data includes an initial sequence number. The newly added base stations of the active set of base stations receive the plurality of blocks of data and store the blocks of data in respective D-RLP buffers.

One of the base stations, i.e., serving base station, of the active set of base stations transmits forward link data to the mobile station at any one time. In one embodiment of the present invention, only one of the base stations transmits data to the mobile station at any one time. Thus, the serving base station transmits blocks of data to the mobile station and the mobile station receives the blocks of data.

Upon a successful receipt of a block of data, the mobile station transmits a confirmation to the serving base station that it received a particular block of data. In this confirmation, the mobile station identifies the block of data received. The serving base station receives this sequence number and compares the sequence number to the sequence number of the first data block in its D-RLP buffer.

When the sequence number of a block of data successfully received by the mobile station exceeds the initial sequence number by a threshold value, as determined by the serving base station, the serving base station notifies the base station controller. In response to this notification, the base station controller downloads a next plurality of blocks of data from the C-RLP buffer to each base station of the active set of base stations.

In performing these operations, the contents of each of the D-RLP buffers is synchronized with the C-RLP buffer. Further, the contents of each D-RLP buffer is synchronized with each other of the D-RLP buffers as well. Because the mobile station may be service by any of the base stations of the active set of base stations at any time, when serving base station is altered, i.e., the mobile station receives forward link transmissions from another of the base stations of the active set of base stations, little interruption of data flow occurs. Thus, streaming operations may be supported.

According to one particular embodiment of the present invention, the first block of data is identified with an initial sequence number. This initial sequence number is consistently maintained the C-RLP buffer and all D-RLP buffers. Further, each of the D-RLP buffers also maintains pointers to the sequence number of the next block of data to be transmitted to the mobile station, and the sequence number of the last block of data that was successfully received by the mobile station. These last two pointers may differ for each of the D-RLP buffers.

When the serving base station receives a sequence number from the mobile station, identifying a last data block successfully received by the mobile station, the serving base station compares the sequence number to the initial sequence number. When the difference between these sequence numbers exceeds a threshold, an indication is sent to the base station controller, which initiates the download of another plurality of blocks of data to the base station D-RLP buffers.

As was described, a base station controller, along with a plurality of base stations, may perform these operations. However, other network components of the cellular wireless network may perform these operations in lieu of, or in addition to these components. Further, these operations may be embodied in software instructions that are executed by at least one cellular wireless network components.

Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered in conjunction with the following drawings, in which:

FIG. 1 is a system diagram illustrating a portion of a cellular wireless network constructed according to the present invention;

FIG. 2 is a system diagram illustrating another portion of the cellular wireless network constructed according to the present invention;

FIG. 3A is a block diagram illustrating an Industry Standards Organization (ISO) Open Systems Interconnection (OSI) protocol stack supported according to the present invention;

FIG. 3B is a block diagram illustrating portions of the cellular wireless network and the manner in which the OSI components are serviced according to the present invention;

FIG. 4 is a system diagram illustrating another portion of the cellular wireless network constructed according to the present invention that is used to illustrate the manner in which high data rate forward link transmissions are serviced;

FIG. 5 is a block diagram employed in describing operation according to the present invention in managing RLP buffer contents;

FIG. 6 is a logic diagram illustrating operation of a base station controller according to the present invention in managing C-RLP buffer contents;

FIG. 7 is a logic diagram illustrating operation of a base station according to the present invention in managing D-RLP buffer contents;

FIG. 8 is a block diagram employed in describing operation according to the present invention in managing RLP buffer contents;

FIG. 9 is a block diagram illustrating a base station constructed according to the present invention;

FIG. 10 is a block diagram illustrating a mobile station constructed according to the present invention;

FIG. 11 is a block diagram illustrating a Base Station Controller (BSC) constructed according to the present invention; and

FIG. 12 is a block diagram illustrating a Packet Data Serving Node (PDSN) constructed according to the present invention.

### DETAILED DESCRIPTION OF THE DRAWINGS

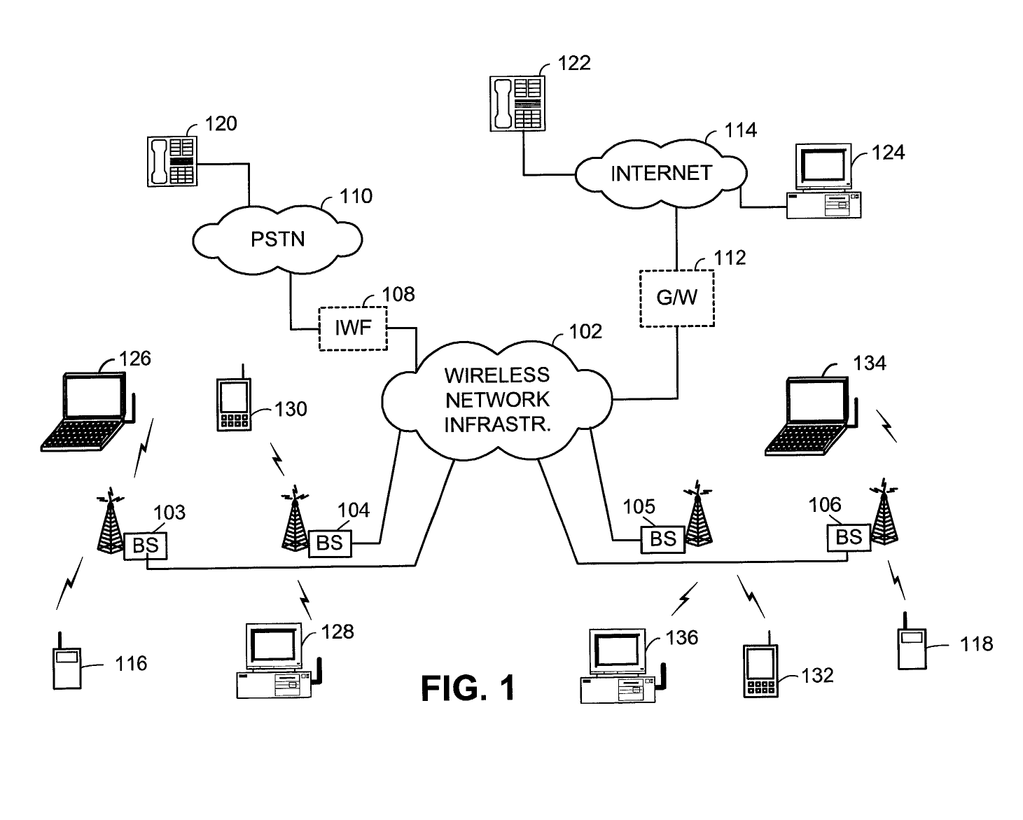

FIG. 1 is a system diagram illustrating a portion of a cellular wireless network constructed according to the present invention. The cellular wireless network includes a wireless network infrastructure 102 and base stations 103, 104, 105, and 106. The wireless network infrastructure 102 couples to the Internet 114 via a gateway (G/W) 112. The wireless network infrastructure 102 also couples to the Public Switched Telephone Network (PSTN) 110 via an interworking function (IWF) 108.

A conventional voice terminal 120 couples to the PSTN 110. A VoIP terminal 122 and a server computer 124 couple to the Internet 114. Mobile stations 116, 118, 126, 128, 130, 132, 134, and 136 wirelessly couple to the wireless network via wireless links with the base stations 103-106. As illustrated, mobile stations may include cellular telephones 116 and 118, laptop computers 126 and 134, desktop computers 128 and 136, and data terminals 130 and 132. However, the wireless network supports communications with other types of mobile stations as well.

Each of the base stations 103-106 services a cell/set of sectors within which it supports wireless communications. Wireless links that include both forward link components and reverse link components support wireless communications between the base stations and their serviced mobile stations. These wireless links support both data communications and voice communications, including both VOIP and circuit-switched voice. The teachings of the present invention may be applied equally to any type of packetized communication.

However, data communications having a high data rate forward link requirement are particularly benefited by the present invention. An example of such a communication occurs when a streaming or delay sensitive data communication is setup between server computer 124 and mobile station 132, for example. In such case, the cellular wireless network must support these high data rate transmissions to the mobile station 132, even while the mobile station 132 roams from base station to base station of base stations 103-106.

The cellular system operates according to a high data rate standard such as the HSDPA standard, the 1×EV-DO standard, the 1×EV-DV standard, or the high data rate standard that is modified or otherwise operates according to the present invention. According to these operating standards, each of the base stations supports one or more high data rate forward channels (F-CHs). In some embodiments, the F-CH is a spread-spectrum time multiplexed channel that services only a single mobile station at any given time. To increase channel throughput, the forward link transmissions of the F-CH may be modulated with a set of Walsh codes prior to its transmission to increase diversity. Thus, the F-CH uses no code sharing to distinguish mobile stations.

As described, any of the base stations 103-106 may serve the high data rate forward link to a mobile station, (e.g., mobile station 132). However, the data path within the wireless network infrastructure 102 will be altered when the mobile station 132 receives high data rate forward link transmissions from a differing base station. For example, when a communication is set-up that is initially serviced by base station 105, data is buffered at base station 105 and then transmitted to the mobile station 132. However, when the mobile station receives forward link data from another base station, e.g., base station 106, the forward link data is not present in the base station 106. Thus, prior systems inherently included a delay period that resulted from loading transmit data into the new serving base stations. Such delay period caused a gap to occur in the ongoing data transmissions. When the cellular network services streaming operations, such as streaming audio and streaming video, this gap is intolerable. The present invention also supports fast switching from one serving base station to another under varying channel condition. This is to ensure the mobile station always receives from the base station with the strongest signal strength.

Thus, according to the present invention a buffering scheme is employed in which a central buffer present in a base station controller, for example, synchronizes its contents with a plurality of distributed buffers resident in a plurality of base stations making up an active set a base stations servicing a mobile station. In this buffering scheme, multiple copies of data intended for the mobile station 132 are maintained in each of the base stations, (e.g., base stations 105 and 106) in the active set for the mobile station 132. Thus, when a mobile station requests forward link transmissions from any of the base stations in its active set, data will continue to be transmitted to the mobile station without a gap in transmissions.

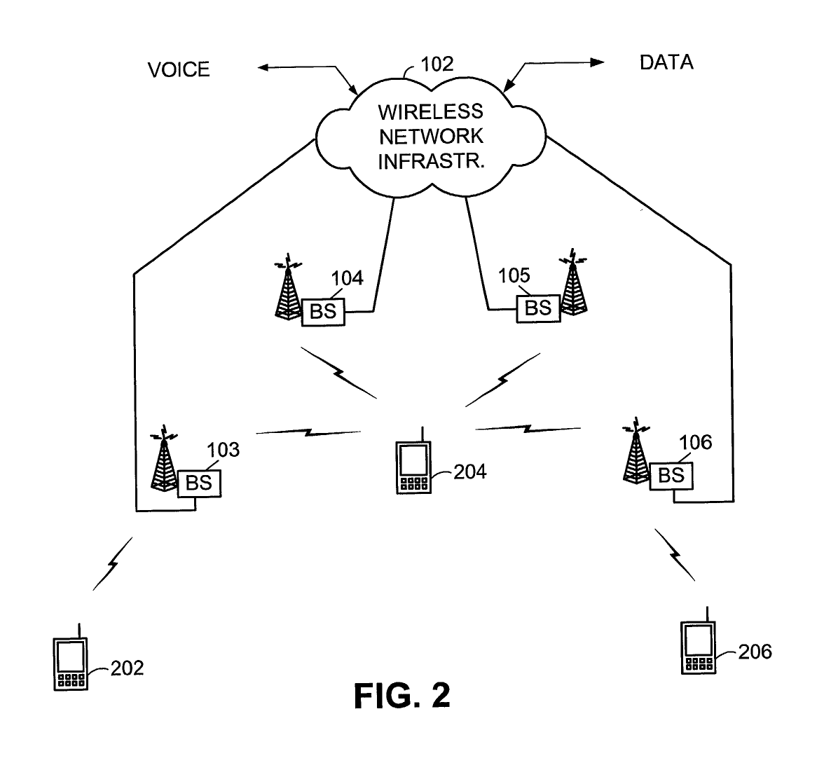

FIG. 2 is a system diagram illustrating another portion of the cellular wireless network constructed according to the present invention. As shown in FIG. 2, the wireless network infrastructure 102 interfaces to both voice and data networks. The voice and data networks are not shown in detail here for simplicity in description. Base stations 103, 104, 105, and 106 each support wireless communications with a mobile station as the mobile station moves from position 202 through position 204 and into position 206.

The wireless network determines an active set of base stations for servicing the mobile station. This active set changes dynamically based upon the quality of transmissions provided to the mobile station and may also be based upon the resources available at the base stations. Selection of an active set of base stations for a mobile station is generally known.

In the example of FIG. 2, with the mobile station at position 202, base station 103 and base station 104 make up the active set of base stations for the mobile station 202. Further, with the mobile station at position 204, base stations 103, 104, 105, and 106 make up the active set of base stations for the mobile station. Finally, with the mobile station at position 206, base stations 105 and 106 make up the active set of base stations for the mobile station.

At position 202, a high data rate forward link operation is established that requires high data rate forward link resources to be provisioned for the mobile station. With base stations 103 and 104 in the active set of the mobile station at position 202, high data rate buffers are filled with data blocks intended for the mobile station. Should one of the buffers in either base station 103 or 104 require refilling, the buffers in both base stations 103 and 104 are refilled. At any time therefore, both base stations 103 or 104 of the active set of the mobile station includes a current set of data. Thus, at position 202, the mobile station may receive high data rate forward link transmissions from either base station 103 or 104 without causing a gap in data transmissions to occur.

As the mobile station moves to position 204, its active set of base stations is altered to include base stations 103, 104, 105, and 106. Thus, with the mobile station at position 204, the distributed buffers in each of base stations 103, 104, 105, and 106 includes current buffer contents. When a refill condition is detected, the buffers of each of these base stations 103, 104, 105, and 106 are refilled to service forward link transmissions. Thus, in this case as well, the base station may receive high data rate forward link transmissions from any of base stations 103, 104, 105, or 106 without any gap in data transmissions occurring.

With the mobile station at position 206, the active set of base stations for the mobile station includes base station 105 and base station 106. In such case, the buffers of both base stations 105 and base station 106 are synchronized to include a current set of transmit data. Further, when either of the buffers of base station 105 or base station 106 requires refilling, both of the buffers are refilled.

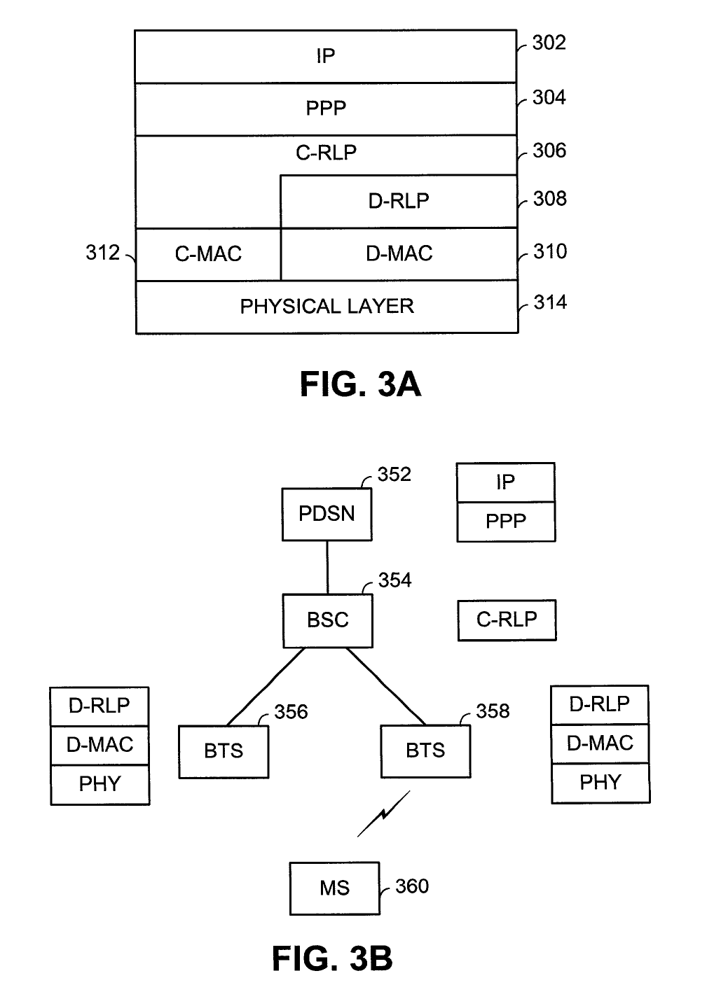

FIG. 3A is a block diagram illustrating an Industry Standards Organization (ISO) Open Systems Interconnection (OSI) protocol stack supported according to the present invention. This protocol stack includes an Internet Protocol (IP) layer 302, a Point-to-Point Protocol (PPP) layer 304, and additional layers residing below the PPP 304 layer. Immediately below the PPP layer 304, is a Radio Link Protocol (RLP) layer. The RLP layer includes a centralized RLP component (C-RLP) 306 and a distributed RLP component (D-RLP) 308. A centralized and distributed RLP structure is employed to adequately service transmissions on the high data rate forward link.

Residing below the RLP layer is a Media Access Control (MAC) layer. The MAC layer includes a centralized MAC component (C-MAC) 312 and a distributed MAC component (D-MAC) 310. Residing below the MAC layer is the physical layer 314. The components of the ISO protocol stack supported according to the present invention illustrated in FIG. 3A are generally known. Thus, these components will not be described other than to expand upon the principles of the present invention.

FIG. 3B is a block diagram illustrating portions of the cellular wireless network and the manner in which the OSI components are serviced according to the present invention. As shown in FIG. 3B, some of the protocol components shown in FIG. 3A are distributed among a plurality of cellular wireless network components. A packet data serving node (PDSN) 352 supports the IP 302 layer and PPP 304 layers. A base station controller (BSC) 354 supports the C-RLP 306 component of the RLP layer. Base station Transceiving Subsystems (BTS) 356 and 358, each associated with the other components of a respective base station, support the D-RLP 308 components of the RLP layer, the D-MAC 310 components of the MAC layer, and the physical layers 314.

The term “base station” was used with reference to FIGS. 1 and 2. Each base station includes a BTS, a tower, and an antenna. The BTS includes the electronic components of the base station. Thus, in some subsequent description, the term BTS is used in conjunction with the description of some operations, protocol layers, etc. The reader should understand that each BTS corresponds to a particular base station and the description herein should be read with this in mind.

According to the present invention, the active set of base stations includes BTSs 356 and 358. Thus, either of BTSs 356 or 358 may transmit high data rate forward link data to mobile station 360 at any time. According to the fast cell switching operations of the present invention, the active BTS, BTS 356 or BTS 358, may be changed at any given time. Thus, in order to avoid loss of data, a D-RLP buffer present in BTS 356 and a D-RLP buffer contained in BTS 358 must both contain a current set of data for transmission to mobile station 360. A copy of the C-RLP buffer is substantially maintained in each D-RLP buffer at any given time. Therefore, when the serving BTS is changed, e.g., from BTS 356 to BTS 358, a complete set of D-RLP buffer contents is available for transmission to the mobile station 360 at the BTS 358.

When a new BTS is added to the active set of base stations, the D-RLP buffer in the newly added base station does not include a copy of the contents of the C-RLP buffer nor are resources in the newly added base station available for servicing high data rate forward link transmissions to the mobile station 360. Thus, in one embodiment, the newly added BTS is precluded for service use until the resources are added and the D-RLP buffer of the BTS is filled.

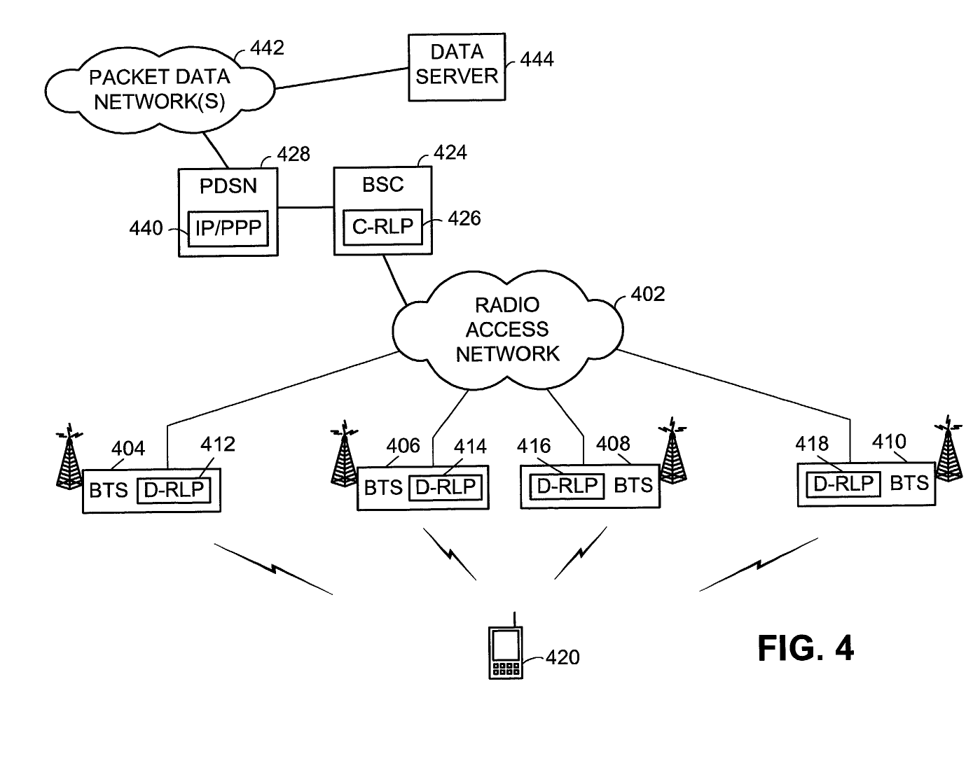

FIG. 4 is a system diagram illustrating another portion of the cellular wireless network constructed according to the present invention that is used to illustrate the manner in which high data rate forward link transmissions are serviced. FIG. 4 is used to illustrate the structure of the cellular wireless network as it relates to the addition of base stations/BTSs to the active set of base stations. In the example of FIG. 4, BTS 404, BTS 406, BTS 408 and BTS 410 are components of base stations currently in the active set of base stations for mobile station 420. These BTSs couple to a radio access network 402. Coupled to the radio access network 402 is BSC 424 which couples to packet data networks 442 via packet data serving node (PDSN) 428.

An example of an operation supported according to the present invention, a data server 444, coupled to packet data network 442, provides high data rate data to mobile station 420. These forward link transmissions are serviced according to a high data rate forward link standard and include a wireless forward link from one of base stations 404, 406, 408, and 410. The forward link data provide is in the form of a streaming data communication (e.g., streaming video data, streaming audio data, etc.). This streaming data is provided to the mobile station 420 across a high data rate forward link according to the present invention. The present invention also supports fast switching between base stations for other less delay sensitive data communication, which is necessary under varying mobile channel condition.

During a first period of operation, BTSs 404 and 406 correspond to base stations in the active set of base stations. Thus, at any time, high data rate forward link transmissions may be transmitted to mobile station 420 via either BTS 404 or BTS 406. In such case, D-RLP 412 buffer present in BTS 404 and D-RLP 414 buffer present in BTS 406 are managed by the C-RLP 426 in BSC 424. In performing this management, a substantially complete copy of a C-RLP buffer contained in BSC 424 is maintained in each D-RLP buffer. The C-RLP buffer interacts with IP/PPP buffers in the PDSN 428 to service the high data rate forward link data transmissions to mobile station 420.

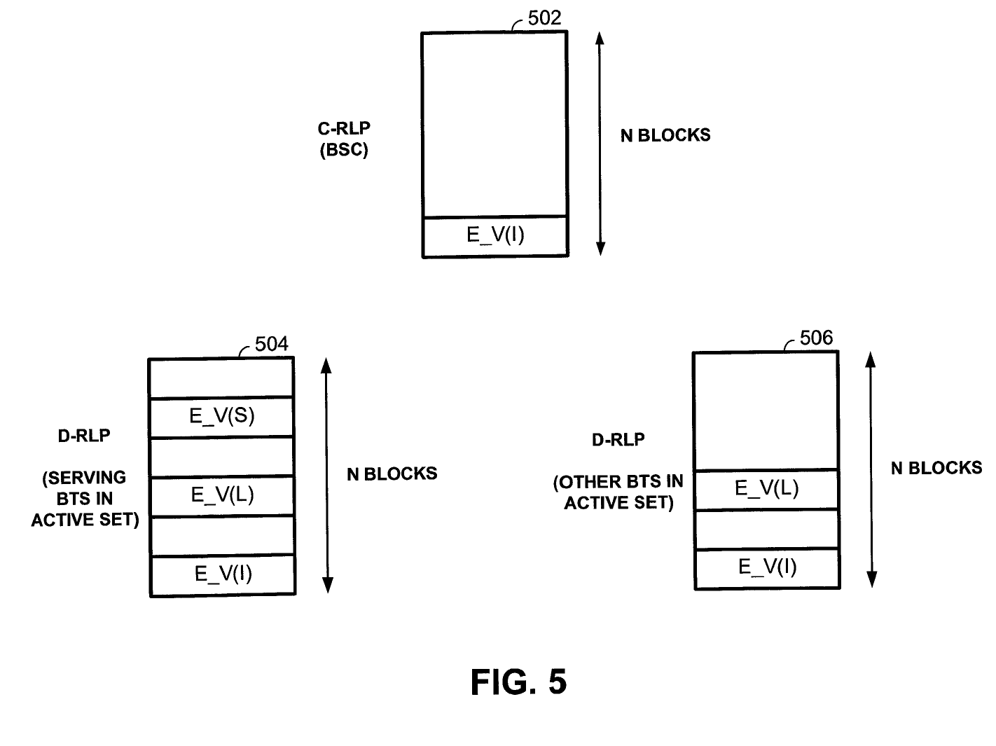

When a refilling requirement for any of the D-RLP buffers is detected, each D-RLP currently in the active set of base stations for the mobile station is refilled. The manner in which a refilling requirement is detected will be described further with reference to FIGS. 5-8.

The active set of base stations may subsequently be altered to include base stations corresponding to BTS 404, BTS 406, and BTS 408. However, with BTS 408 being added to the active set of base stations, a D-RLP 416 buffer contained in BTS 408 is empty and does not include a current copy of the C-RLP 426 buffer nor are forward link resources in BTS 408 allocated for servicing a high data rate forward link to mobile station 420.

Thus, according to the present invention, the BTS 408 is not available for servicing high data rate forward link transmissions to mobile station 420 until the D-RLP 416 buffer is filled with forward link data and BTS 408 resources for servicing the forward link are allocated. A similar operation occurs when the active set of base stations is altered to include base station/BTS 410.

FIG. 5 is a block diagram employed in describing operation according to the present invention in managing RLP buffer contents. As shown in FIG. 5, a centralized radio link protocol (C-RLP) buffer 502 is resident in a BSC servicing the forward link data communications to the mobile station. Further, resident in each BTS/base station in the active set of the mobile station is a distributed RLP buffer (D-RLP), buffer 504, and buffer 506. For example, FIG. 5 shows two BTSs currently in the active set of the mobile station. In such case, D-RLP buffer 504 is currently serving forward link transmissions to the mobile station while D-RLP buffer 506 remains ready to service forward link transmissions to the mobile station. According to the high data rate forward link standards, based upon the quality of the forward link available from any of the BTSs or base stations in the active set of the mobile station, the mobile station may request forward link transmissions from any BTS in the active set of base stations.

Therefore, according to the present invention synchronization of the C-RLP buffer 502 and the D-RLP buffers 504 and 506 is performed. In order to maintain synchronization between the C-RLP buffer and D-RLP buffers, each block of data received from upper layer protocols, (e.g., IP/PPP) is uniquely identified by an extended sequence number. The upper layer protocol data flows to the C-RLP buffer 502 and then is multi-cast to the D-RLP buffers buffer 504 and buffer 506, which are resident in the BTSs of the mobile station's active set of base stations.

At the beginning of the data communication, and before the mobile station begins communicating with its serving BTS, the C-RLP buffer 502 and the D-RLP buffers 504 and 506 are synchronized to contain the same set of data blocks. The data blocks stored in the C-RLP buffer 502 and the D-RLP buffers 504 and buffer 506 include sequence numbers identifying the various blocks of data. For example, referring to the contents of the C-RLP buffer 502 and D-RLP buffers 504 and buffer 506, N blocks of data are stored in each of the RLP buffers. The first data block in the buffers is referenced with the sequence number E_V(I). Additional indices are tracked in the D-RLP buffers 504 and 506. The index E_V(L) represents the extended sequence number of the last data block delivered from the mobile station's sequencing buffer to its upper layers. E_V(L) is reported on the reverse link to the serving base station of the active set. Thus, any time that the mobile station successfully receives a data block and passes the data block to its upper layer protocols, the mobile station reports the sequence number to its serving BTS. In another embodiment, the mobile station reports E_V(L) to each base station in its active set of base stations.

The base stations in the active set also track the sequence number E_V(S) of the next new block of data to send to the mobile station. The index E_V(S) is kept by the currently serving BTS to identify the next data block to send to the mobile station. When the mobile station reports E_V(L) to only its serving base station, the various base stations in the active set may have differing E_V(L) indices. However, when each of the base stations receives E_V(L) from the mobile station, each of the base stations in the serving set will have the same value for E_V(L).

At the beginning of the data communication before the mobile station begins communicating with a serving BTS, each of the C-RLP and D-RLP buffers contain the same set of data blocks with the sequence number starting from E_V(I). Also, at this point with the C-RLP buffer 502 and the D-RLP buffers 504 and 506 synchronized, E_V(S)=E_V(I), E_V(L)=E_V(I)−1.

As the serving BTS starts transmitting data blocks to the mobile station, E_V(S) of the serving D-RLP buffer 504 starts incrementing. On the reverse link the mobile station reports to all of the BTSs in the active set the last data block sequence number delivered to its upper protocol layers. Each of the active set of base stations will update their E_V(L) to the value reported by the mobile station. The reporting from the mobile station may be either periodic (with a predefined period) or based on a threshold.

With each D-RLP tracking its buffer contents in the indices for the sequence numbers, when E_V(L)−E_V(I)+1 reaches a predefined threshold, the serving D-RLP (or multiple of the base stations in the active set) sends an indication to the C-RLP. The C-RLP then multicasts E_V(L)−E_V(I)+1 blocks of new data to the D-RLP buffers in the active set. These new blocks of data are stored in the D-RLP buffers 504 and 506. Each of the D-RLP discards from its D-RLP buffer, the number of data blocks corresponds to the number of new data blocks received from the C-RLP, starting from the block with extended sequence number, E_V(I). Further, the C-RLP 502 and each of the D-RLP buffers 504 and 506 in the active set then increment their E_V(I) indices to be equal to E_V(I) +[the number of new data blocks received from the C-RLP].

These operations are repeated until the mobile station's data communication is complete at which time operation ends. Thus, during the pendency of the data communication across the forward link, the contents of the D-RLP buffers 504 and 506 are synchronized with the contents of the C-RLP buffer 502 so that data will not be lost when a mobile station moves from being served by one base station to being served by other base stations in the active set.

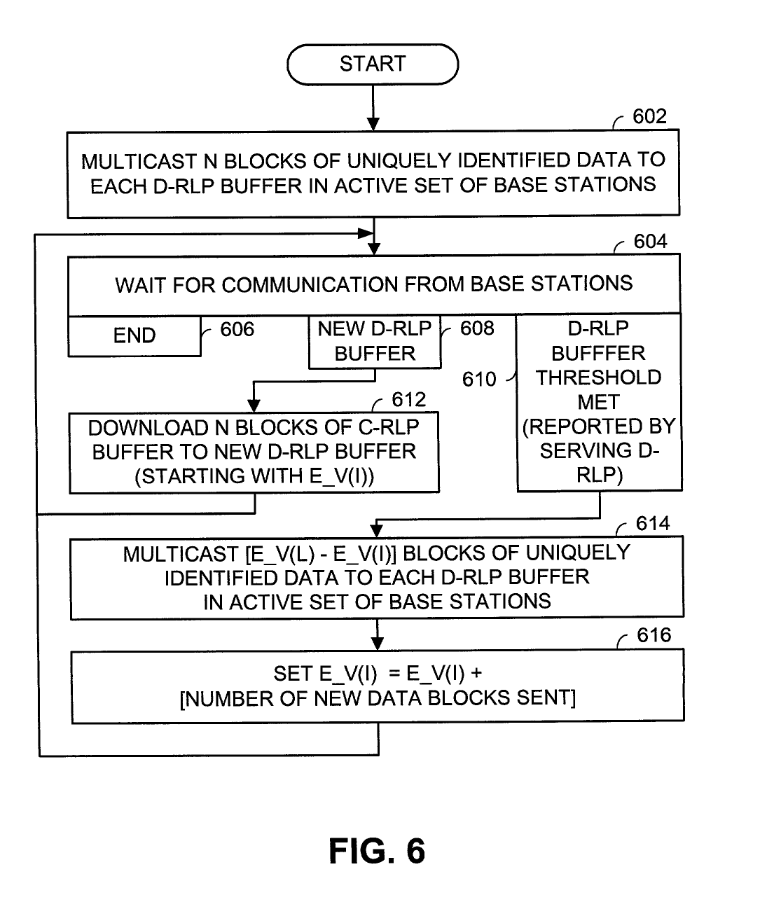

FIG. 6 is a logic diagram illustrating operation of a BSC according to the present invention in managing C-RLP buffer contents. Operation of FIG. 6 starts when the BSC multi-casts N blocks of uniquely identified data from its C-RLP buffer to each D-RLP buffer in the active set of base stations for the mobile station (step 602). As was described with reference to FIG. 5, each of the N blocks of uniquely identified data includes an extended sequence number. The first of these N blocks of uniquely identified data has a sequence number E_V(I). The last of these N blocks would then therefore have an extended sequence number equal to E_V(I)+N−1. However, because the sequence numbers wrap around, the actual sequence numbers may not be linearly in order.

Once the BSC transmits the N blocks of uniquely identified data from its C-RLP, it waits for communications from any of the base stations in the active set having D-RLP buffers that it supports (step 604). Prior to receiving a communication from a serviced base station, or upon receipt of a communication, operation may end (step 606). When the communication has ended, the BSC will deallocate any resources it has allocated for the data communication, including resources it provides and resources in the plurality of base stations in the active set.

Another operation serviced by the BSC occurs when the active set of base stations serving the mobile station changes. In such case, the BSC will determine that a new base station having a new D-RLP buffer requiring servicing is present (step 608). When the new D-RLP buffer is identified, the BSC will download N blocks of uniquely identified data starting with data block E_V(I), from its C-RLP buffer to the new D-RLP buffer (step 612). In downloading the copy of the C-RLP buffer, the sequence numbers of each of the uniquely identified N blocks of data will also be included. Thus, the receiving D-RLP buffer is able to identify the sequence value E_V(I). After the BSC has downloaded a copy of its C-RLP buffer to the new D-RLP buffer, operation returns to step 604 where the BSC waits further communications.

From step 604, the BSC may also receive a report from a serving BTS/base station that the D-RLP buffer threshold has been met (step 610). In such case, the BSC will multi-cast a number of uniquely identified data blocks to each of the DRLP buffers in the active set of base stations for the mobile station (step 614). The number of data blocks will be equal to a value corresponding to a threshold. This threshold in one embodiment is equal to (E_V(L)−E_V(I)+1). This value represents the number of data blocks that have been successfully transmitted from the serving base station/BTS to the mobile station. Thus, in such case, this number of data blocks is required for multi-casting to the plurality of D-RLP buffers to fully refresh and fill the D-RLP buffers.

After the BSC layer has transmitted the new blocks of uniquely identified data to the D-RLP buffers, the BSC resets the E_V(I) value to represent the extended number of the data block at the start of the D-RLP buffers (step 616). Thus, upon a next execution of steps 610 through 614, a next new set of data blocks will be transmitted to the D-RLP buffers. From step 616, operation proceeds again to step 604.

The base station may also support other techniques for determining a number of data blocks in its D-RLP transmit buffer are no longer required, with or without reporting from the mobile station. In one alternate operation, the base station limits the duration of time during which a data block should remain in the D-RLP buffer after it has been sent to the mobile station. After this time period is met for enough data blocks, the base station will report to the BSC that its D-RLP buffer requires refilling. With this operation, no reporting is required from the mobile station. As with the other described embodiments, when the criteria is met, the base station will notify the base station controller to multicast new blocks of data.

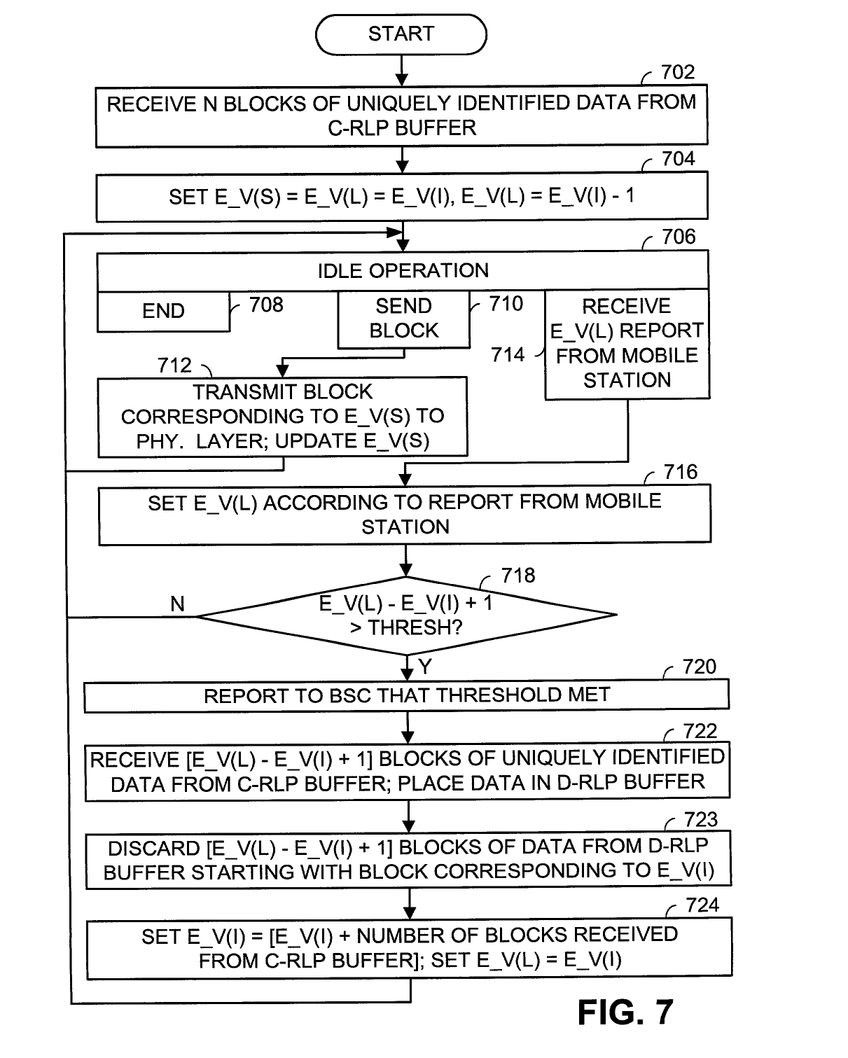

FIG. 7 is a logic diagram illustrating operation of a base station according to the present invention in managing RLP buffer contents. In an operation, the base station's D-RLP buffer receives N blocks of uniquely identified data from the C-RLP buffer operating on a serving BSC (step 702). Upon receipt of these N blocks of uniquely identified data from the C-RLP buffer, the base station sets each of its indexing values to the extended sequence number of the first new block of data received from the C-RLP buffer. In such case, the base station sets E_V(S)=E_V(I), E_V(L)=E_V(I)−1 (step 704).

The base station then enters an idle operation awaiting input from either the mobile station or the BSC (step 706). One such operation occurs when the transmission for which the data communication ends (step 708). Another operation occurs when the D-RLP layer of the base station transmits a block of data from its D-RLP buffer to the physical layer serving the base station/mobile station (step 710). In such case, the D-RLP layer operating on the base station passes a block of data corresponding to E_V(S) to the physical layer. In such case, the D-RLP also increments the pointer E_V(S) by one extended sequence number (step 712). In some operations, the D-RLP may send multiple blocks of data from its D-RLP buffer to the physical layer serving the mobile station. In such case, the base station layer updates E_V(S) by the number of data blocks sent to the physical layer.

The base station will also periodically receive reports from the mobile station indicating the extended sequence number of the last block of data delivered from the mobile station's resequencing buffer in its D-RLP layer to its upper layer protocols (step 714). In such case, the base station sets the value E_V(L) to the sequence number reported by the mobile station (step 716). As was previously described, each of the BTSs/base stations in the active set of the mobile station may receive this extended sequence number from the mobile station on a respective reverse link.

With the new value of E_V(L), the base station then determines whether the value [E_V(L)−E_V(I)+1] is greater than threshold (step 718). This determination indicates whether a refresh of the D-RLP buffer is required. If such a refresh is not required then operation returns to step 706. However, if this threshold is met and refresh of the D-RLP buffer is required, the D-RLP protocol layer of the base station reports to the C-RLP protocol layer of the BSC that the threshold is met (step 720).

After the BSC has responded to this report, the base station will receive [E_V(L)−E_V(I)+1] blocks of uniquely identified data from the C-RLP buffer and will then place this new set of data blocks into its D-RLP buffer (step 722). The base station then discards from its D-RLP buffer, a number of data blocks corresponds to the number of new data blocks received from the C-RLP [E_V(L)−E_V(I)+1], starting from block with extended sequence number, E_V(I) (step 723). The base station will then increment E_V(I) equal to [E_V(I)+the number of blocks of data received from the C-RLP protocol layer] . At this time, the base station will also set E_V(L)=E_V(I)−1 (step 724). From step 724, operation returns to step 706.

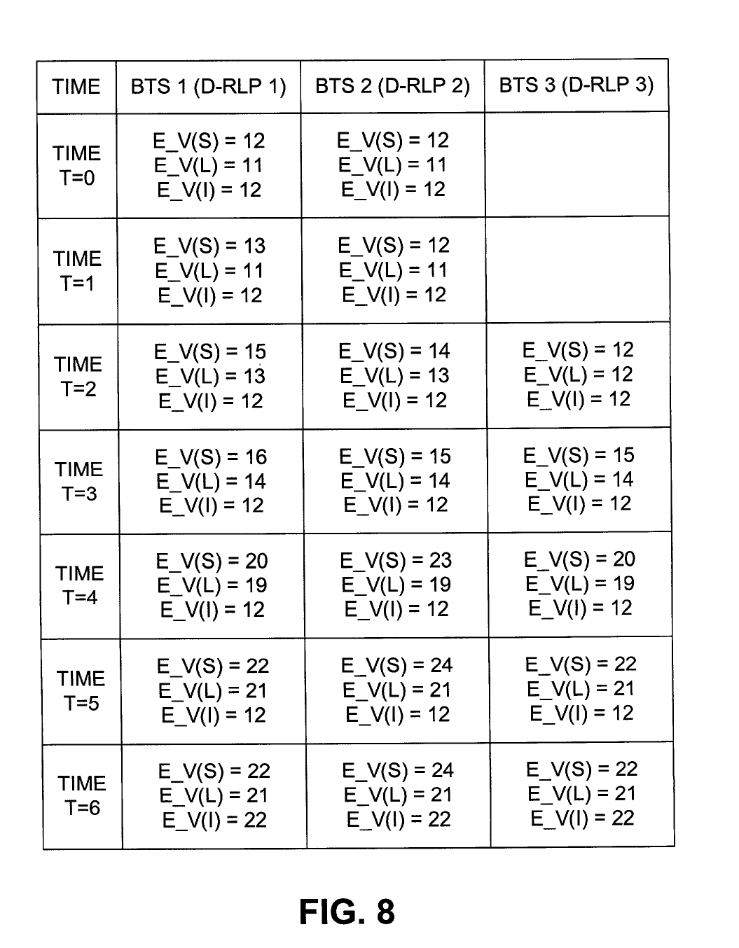

FIG. 8 is a block diagram employed in describing operation according to the present invention in managing RLP buffer contents. FIG. 8 considers six different instances in time. At these six separate instances of time, the index values E_V(S), E_V(L), and E_V(I) are considered for each BTS of the active set of base stations serving a mobile station. At time equal to 0, a data communication has just commenced. At such time, BTS 1 and BTS 2 are in the active set of the mobile station.

At time T=0, therefore, BTS 1 and BTS 2 have each received N blocks of data from the C-RLP buffer and stored in their D-RLP buffers these N blocks of data. Thus, at time 0, the indices E_V(I) and E_V(S) are set to the extended sequence number of the next new block to be sent to the mobile terminal. E_V(L) is then set to E_V(I)−1. In such case, E_V(I) is set to the decimal number 12 and E_V(L) is set to the decimal number 11. However, in an actual application, the extended sequence number will be a binary number and the decimal numbers used herein are to simplify the current explanation.

At time T=1, 1 block of data has been transmitted by BTS 1 to the mobile station. In such case, the RLP layer in BTS 1 has updated the index E_V(S) to 13. Such updated index represents the extended sequence number of the next new block of data to send to the mobile station. As is further shown, the indices E_V(I), E_V(L), and E_V(S) maintained by the D-RLP layer in BTS 2 are unchanged.

Between time T=1 and time T=2, BTS 3 is added to the active set of base stations serving the mobile station. In such case, a copy of the C-RLP buffer is downloaded to the D-RLP buffer in BTS 3. In such case therefore, the D-RLP layer resident in BTS 3 sets the indices E_V(I) and E_V(S) equal to the extended sequence number of the first block in its D-RLP buffer. E_V(L) is then set to E_V(I)−1. Further, BTS 1 continues to service forward link transmission for the mobile station. The mobile station has reported the extended sequence number of the last block it delivered from its RLP resequencing buffer to its upper layer protocols. This extended sequence number is represented as 13. Thus, the BTS 1 and BTS 2 D-RLP layers have updated the index E_V(L) to 13to indicate the extended sequence number of the last block delivered from the mobile station resequencing buffers to the upper layer protocols.

At time T=2, BTS 1 has already transmitted an block of data corresponding to extended sequence number 14 to the mobile station. Thus, the BTS 1 D-RLP layer has updated the index E_V(S) to be equal to 15. Further, because of the reported value of the extended sequence number of the last block delivered from the mobile station D-RLP resequencing buffer to its upper level protocols as 13, BTS 2 has updated the index E_V(S) equal to 14.

At time T=3, BTS 1 continues to serve the mobile station. However, the mobile station has previously reported that the extended sequence number of the last block it delivered from its RLP resequencing buffer to the upper layer supported in the mobile station is 14. Thus, each of BTS 1, BTS 2, and BTS 3 has updated their respective index E_V(L) to 14. Further, BTS 2 and BTS 3, which are not currently serving the mobile station, have updated their E_V(S) indices to be equal to 15, which is one extended sequence number greater than the number reported by the mobile station for successful receipt. Further, BTS 1, which continues to service the mobile stations forward link transmissions, has updated its index E_V(S) equal to 16 to indicate the next new block of data to send to the mobile station.

Between time T=3 and time T=4, BTS 1 ceases to serve the mobile station and BTS 2 commences serving the mobile station.

At time T=4, the mobile station has reported that the extended sequence number of the last block it delivered from its RLP resequencing buffers to the upper layer of protocols was 19. Thus, each of BTS 1, BTS 2, and BTS 3 D-RLP layers has updated the index E_V(L) equal to 19. Further, BTS 1 and BTS 2, which do not currently serve the mobile station, have updated their respective indices E_V(S) to 20. With BTS 2 currently serving the mobile station, it has set its index E_V(S) equal to 23 to represent the extended sequence number of the next new block of data to send to the mobile station.

Referring now to time T=5, BTS 1, BTS 2 and BTS 3 continue to make up the active set of the mobile station while BTS 2 serves the mobile station. Further, the mobile station has reported the extended sequence number of the last block delivered from its RLP resequencing buffer to its upper layer protocols to be 21. Thus, each of the BTSs has set their respective index E_V(L) equal to 21 in response to the mobile stations status report. Further, BTS 2 has set its index E_V(S) equal to 24 to indicate the extended sequence number of the next new block of data to send to the mobile station.

Also at time T=5, the serving BTS determines that the extended sequence number represented by [E_V(L)−E_V(I)+1] is greater than a threshold. Thus, BTS 2 reports to the C-RLP protocol layer of the BSC that the threshold has been exceeded. In response to this report, the BSC transmits [E_V(L)−E_V(I)+1] blocks of new uniquely identified data from its C-RLP buffer to each of the base stations.

At time T=6, each of the D-RLP layers in BTS 1, BTS 2, and BTS 3 receives the new data from the C-RLP. Each of the D-RLP layers in BTS 1, BTS 2, and BTS 3 places the data in its respective D-RLP buffer. Each of the D-RLP layers in BTS 1, BTS 2, and BTS 3 then discards from its respective D-RLP buffer, the number of data blocks corresponds to the number of new data blocks received from the C-RLP, starting from block with extended sequence number, E_V(I). Further, each of the BTSs then sets E_V(I) equal to 22, which represents the extended sequence number of the first block in each of the D-RLP buffers. Each of the BTSs sets E_V(L) =E_V(I)−1=21. Further, BTS 1 and BTS 3 that are not currently serving the mobile station also set E_V(S) to 22. Also note that BTS 2, that is currently serving the mobile stations forward link transmission requirements maintains the same value of E_V(S) at 24.

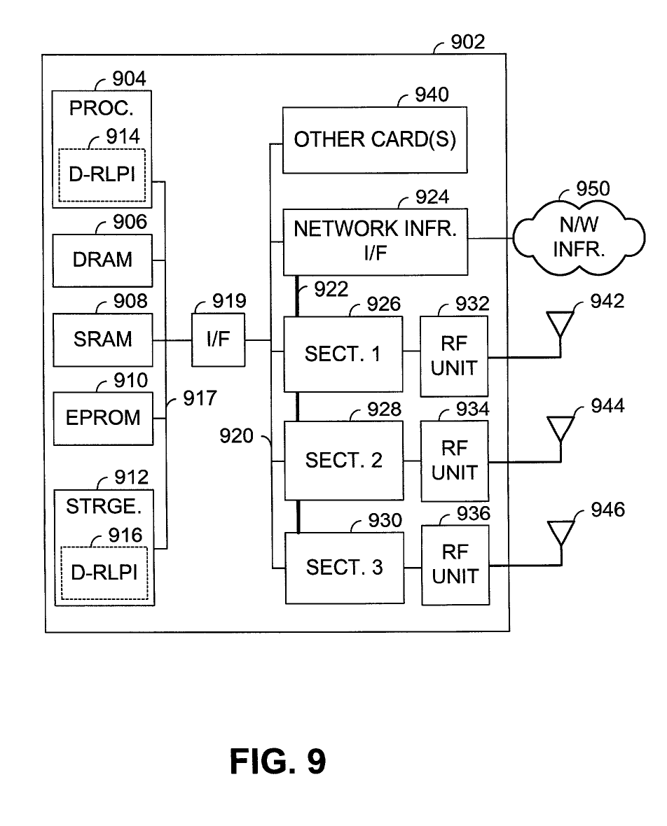

FIG. 9 is a block diagram illustrating a base station/BTS 902 constructed according to the present invention. The BTS 902 supports an operating protocol that is compatible with the teachings of the present invention, with or without modification thereto. The BTS 902 supports protocol layer operations such as those described with reference to FIGS. 2, 3A, and/or 3B.

The BTS 902 includes a processor 904, dynamic RAM 906, static RAM 908, Flash memory, EPROM 910 and at least one data storage device 912, such as a hard drive, optical drive, tape drive, etc. These components (which may be contained on a peripheral processing card or module) intercouple via a local bus 917 and couple to a peripheral bus 920 (which may be a back plane) via an interface 918. Various peripheral cards couple to the peripheral bus 920. These peripheral cards include a network infrastructure interface card 924, which couples the BTS 902 to the wireless network infrastructure 950.

Digital processing cards 926, 928, and 930 couple to Radio Frequency (RF) units 932, 934, and 936, respectively. Each of these digital processing cards 926, 928, and 930 performs digital processing for a respective sector, e.g., sector 1, sector 2, or sector 3, serviced by the BTS 902. Thus, each of the digital processing cards 926, 928, and 930 will perform some or all of processing operations described with reference to FIGS. 6 and 7. The RF units 932, 934, and 936 couple to antennas 942, 944, and 946, respectively, and support wireless communication between the BTS 902 and mobile stations (the structure of which is shown in FIG. 9). The BTS 902 may include other cards 940 as well.

D-RLP Instructions (D-RLPI) 916 are stored in storage 912. The D-RLPI 916 are downloaded to the processor 904 and/or the DRAM 906 as D-RLPI 914 for execution by the processor 904. While the D-RLPI 916 are shown to reside within storage 912 contained in BTS 902, the D-RLPI 916 may be loaded onto portable media such as magnetic media, optical media, or electronic media. Further, the D-RLPI 916 may be electronically transmitted from one computer to another across a data communication path. These embodiments of the D-RLPI are all within the spirit and scope of the present invention.

Upon execution of the D-RLPI 914, the BTS 902 performs operations according to the present invention previously described herein with reference to the base stations/BTSs of FIGS. 1-8. The D-RLPI 916 may also be partially executed by the digital processing cards 926, 928, and 930 and/or other components of the BTS 902. Further, the structure of the BTS 902 illustrated is only one of many varied BTS structures that could be operated according to the teachings of the present invention.

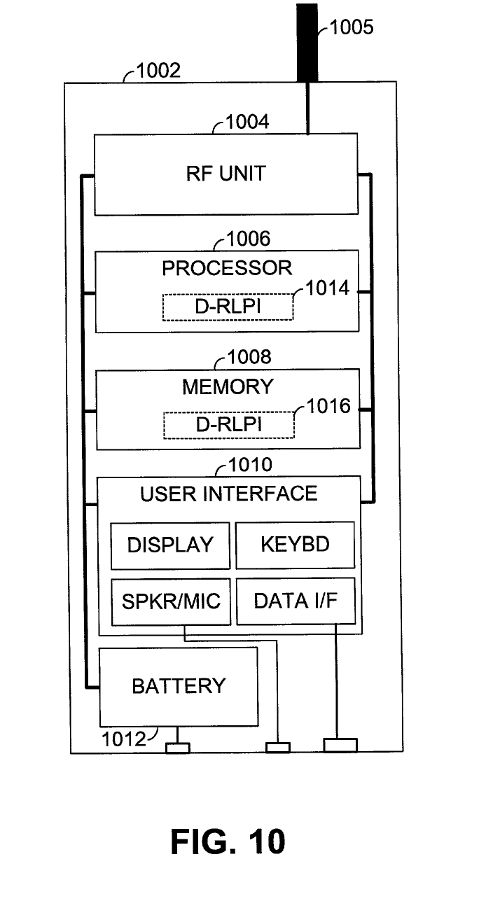

FIG. 10 is a block diagram illustrating a mobile station 1002 constructed according to the present invention that performs the operations previously described herein. The mobile station 1002 supports standardized operations that are compatible with the teachings of the present invention, with or without modification. However, in other embodiments, the mobile station 1002 supports other operating standards.

The mobile station 1002 includes an RF unit 1004, a processor 1006, and a memory 1008. The RF unit 1004 couples to an antenna 1005 that may be located internal or external to the case of the mobile station 1002. The processor 1006 may be an Application Specific Integrated Circuit (ASIC) or another type of processor that is capable of operating the mobile station 1002 according to the present invention. The memory 1008 includes both static and dynamic components, e.g., DRAM, SRAM, ROM, EEPROM, etc. In some embodiments, the memory 1008 may be partially or fully contained upon an ASIC that also includes the processor 1006. A user interface 1010 includes a display, a keyboard, a speaker, a microphone, and a data interface, and may include other user interface components. The RF unit 1004, the processor 1006, the memory 1008, and the user interface 1010 couple via one or more communication buses/links. A battery 1012 also couples to and powers the RF unit 1004, the processor 1006, the memory 1008, and the user interface 1010.

D-RLP Instructions (D-RLPI) 1016 are stored in memory 1008. The D-RLPI 1016 are downloaded to the processor 1006 as D-RLPI 1014 for execution by the processor 1006. The DRLPI 1016 may also be partially executed by the RF unit 1004 in some embodiments. The D-RLPI 1016 may be programmed into the mobile station 1002 at the time of manufacture, during a service provisioning operation, such as an over-the-air service provisioning operation, or during a parameter updating operation. Upon their execution, the D-RLPI 1014 cause the mobile station 1002 to perform operations according to the present invention previously described with reference to the mobile stations of FIGS. 1-8.

The structure of the mobile station 1002 illustrated is only an example of one mobile station structure. Many other varied mobile station structures could be operated according to the teachings of the present invention. Upon execution of the D-RLPI 1014, the mobile station 1002 performs operations according to the present invention previously described herein in servicing a VOIP telephony call.

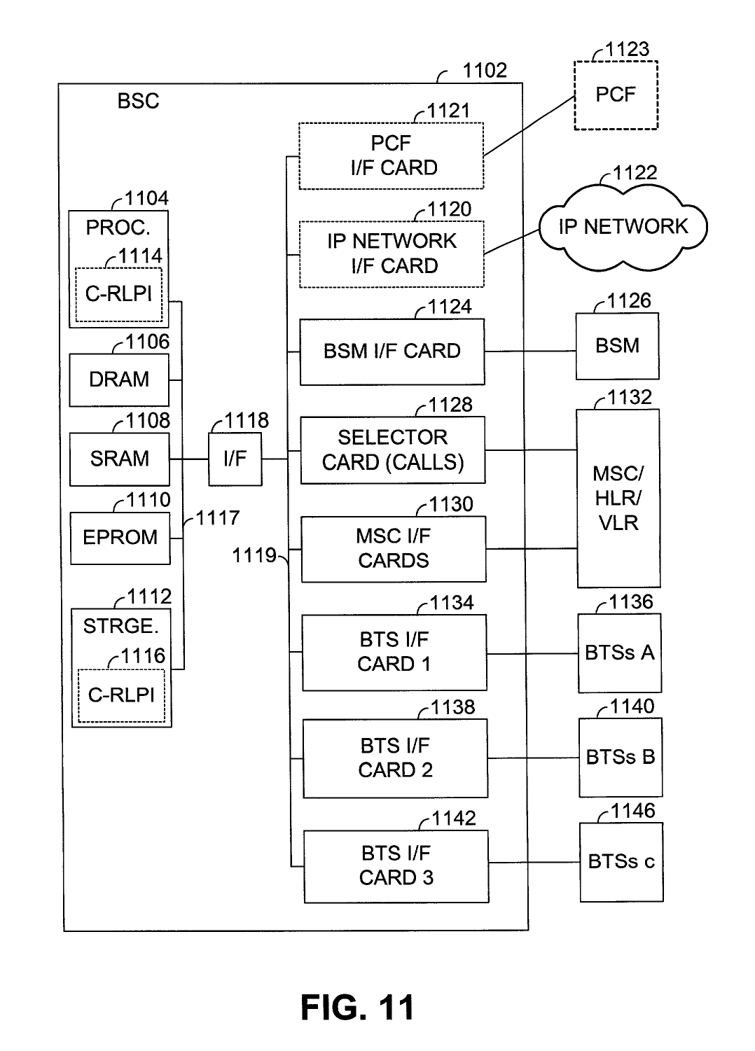

FIG. 11 is a block diagram illustrating a Base Station Controller (BSC) 1102 constructed according to the present invention. The structure and operation of BSCs is generally known. The BSC 1102 services both circuit switched and packet switched operations. In some cases, the BSC 1102 is called upon to convert data between circuit switched and data switched formats, depending upon the types of equipment coupled to the BSC 1102. The components illustrated in FIG. 11, their function, and the interconnectivity may vary without departing from the teachings of the present invention.

The BSC 1102 includes a processor 1104, dynamic RAM 1106, static RAM 1108, EPROM 1110 and at least one data storage device 1112, such as a hard drive, optical drive, tape drive, etc. These components intercouple via a local bus 1117 and couple to a peripheral bus 1119 via an interface 1118. Various peripheral cards couple to the peripheral bus 1119. These peripheral cards include an IP network interface card 1120, a base station manager card 1124, at least one selector card 1128, a MSC interface card 1130, and a plurality of BTS interface cards 1134, 1138 and 1142.

The IP network interface card 1120 couples the BSC 1102 to an IP network 1122. The base station manager interface card 1124 couples the BSC 1102 to a Base Station Manager 1126. The selector card 1128 and MSC interface card 1130 couple the BSC 1102 to the MSC/HLR/VLR 1132. the BTS interface cards 1134, 1138, and 1142 couple the BSC 1102 to base stations served by Base station Transceiver Subsystems (BTSs) 1136, 1140, and 1146, respectively.

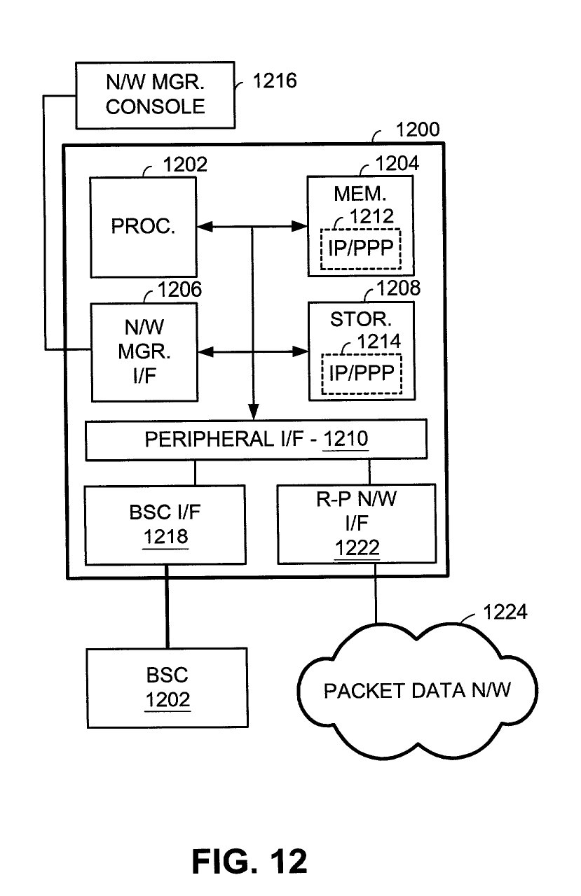

In another embodiment of the present invention, a packet control function (PCF) 1123 is implemented separately from the BSC 1102. In such case, the BSC 1102 couples to the PCF 1123 via a PCF I/F card 1121. However, some of the PCF operations may be performed by a PDSN described with reference to FIG. 12

C-RLP Instructions (C-RLPI), along with the BSC 1102 hardware, enable the BSC 1102 to perform the operations of the present invention. The C-RLPI 1116 are loaded into the storage unit 1112 and, upon their execution, some or all of the C-RLPI 1114 are loaded into the processor 1104 for execution. During this process, some of the C-RLPI 1116 may be loaded into the DRAM 1106.

FIG. 12 is a block diagram illustrating a Packet Data Serving Node (PDSN) 1200 constructed according to the present invention. The PDSN 1200 may be general-purpose computer that has been programmed and/or otherwise modified to perform the particular operations described herein. However, the PDSN 1200 may be specially constructed to perform the operations described herein. In particular, the PDSN 1200 may be the PDSN 114 shown in FIG. 1 or the PDSN 204 illustrated in FIG. 2 that executes some of the operations described with reference to FIGS. 3-4 and 8-11.

Apart from the functions of the present invention, the PDSN 1200 performs functions that are basically the same as those performed by the Network Access Server (NAS) in data networks. A NAS is the entry point to the network and provides the end user with access to network services. In a CDMA2000 system, the PDSN is the entry point to the public data network for MSs. The PDSN resides on the network edge and controls access to network services.

The PDSN 1200 includes a processor 1202, memory 1204, a network manager interface 1206, storage 1208, and a peripheral interface 1210, all of which couple via a processor bus. The processor 1202 may be a microprocessor or another type of processor that executes software instructions to accomplish programmed functions. The memory 1204 may include DRAM, SRAM, ROM, PROM, EPROM, EEPROM, or another type of memory in which digital information may be stored. The storage 1208 may be magnetic disk storage, magnetic tape storage, optical storage, or any other type of device, which is capable of storing digital instructions and data.

The network manager interface 1206 couples to a network manager console 1216, which allows a network manager to interface with the PDSN 1200 via a network manager console 1216. The network manager console 1216 may be a keypad/display or may be a more complex device, such as a personal computer, which allows the manager to interface with the PDSN 1200. However, the network manager may interface with the PDSN 1200 using other techniques as well, e.g., via a card coupled to the peripheral interface 1210.

The peripheral interface 1210 couples to a BSC interface 1218 and to an IP network interface 1222. The BSC interface 1218 couples the PDSN 1200 to the BSC 1102. The IP network interface 1222 couples the PDSN 1200 to an IP network 1224, e.g., a combination of the Internet, Intranets, LANs, WANs, etc. The IP network 1224 is shown generally as the Internet 114 of FIG. 1 and the Packet Data Networks 206 of FIG. 2. The IP network 1224 may be either of these networks or another packet switched network.

IP/PPP protocol instructions (IP/PPP) 1212 are loaded into the storage 1208 of the PDSN 1200. Upon their execution, a portion of the IP/PPP 1212 is downloaded into memory 1204 (as IP/PPP 1214). The processor 1202 then executes the IP/PPP 1214 to perform the operations described herein performed by the PDSN 1200. The programming and operation of digital computers is generally known to perform such steps. Thus, the manner in which the processor 1202 and the other components of the PDSN 1200 function to perform these operations are not further described herein.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A method of operating a wireless communication system to service high data rate forward link transmissions for a mobile station, the method comprising:
determining an active set of base stations for servicing the mobile station;
for each of the active set of base stations, downloading a plurality of blocks of data from a central buffer, wherein each block of data of the plurality of blocks of data includes a respective sequence number, and wherein a first block of data of the plurality of blocks of data includes an initial sequence number;
transmitting blocks of data from a serving base station of the active set of base stations to the mobile station;
receiving a sequence number from the mobile station for each block of data successfully received by the mobile station; and
when the sequence number of a block of data successfully received by the mobile station exceeds the initial sequence number by a threshold value, downloading a next plurality of blocks of data from a central buffer to each base station of the active set of base stations.

2. The method of claim 1, wherein the central buffer is serviced by a base station controller, and wherein the base station controller services the plurality of base stations.

3. The method of claim 2, wherein the central buffer is serviced by a services gateway switching node that services the plurality of base stations.

4. The method of claim 1, wherein only one base station of the active set of base stations services forward link transmissions to the mobile station at any particular time.

5. The method of 4, wherein:
the mobile station reports the sequence number of a successfully received block of data to its serving base station; and
determining that the sequence number of a block of data successfully received by the mobile station exceeds the initial sequence number by a threshold value is determined by the mobile station's serving base station.

6. The method of claim 1, wherein the wireless communication system supports the 1×EV-DO standard.

7. The method of claim 1, wherein the wireless communication system supports the High Speed Downlink Packet Access standard.

8. A method of managing the contents of a plurality of data buffers in a wireless communication system to service forward link data transmissions for a mobile station, the method comprising:
receiving data in a central buffer of a network element of the wireless communication system element, wherein the network element manages a plurality of base stations of the wireless communication system;
downloading a plurality of blocks of data from the central buffer to each of a plurality of distributed buffers resident in a respective plurality of base stations forming an active set of base stations servicing the mobile station;
transmitting blocks of data from a serving base station of the active set of base stations to the mobile station;
determining that distributed buffer refresh is required; and
downloading a next plurality of blocks of data from the central buffer to each of the plurality of distributed buffers resident in the active set of base stations servicing the mobile station.

9. The method of claim 8, wherein:
the central buffer supports centralized link layer buffering operations; and
the plurality of distributed buffers support distributed link layer buffering operations.

10. The method of claim 9, wherein the central buffer and the plurality of distributed buffers support the radio link protocol.

11. The method of claim 8, wherein only one base station of the active set of base stations services forward link transmissions to the mobile station at any particular time.

12. The method of claim 8, wherein the network element is a base station controller.

13. A method of managing the contents of a plurality of data buffers in a wireless communication system to service forward link data transmissions for a mobile station, the method comprising:
receiving data in a central buffer of a network element of the wireless communication system, wherein the network element services a plurality of base stations of the wireless ommunication system;
downloading a plurality of blocks of data from the central buffer to each of a plurality of distributed buffers resident in a respective plurality of base stations that define an active set of base stations servicing the mobile station, wherein each block of the plurality of blocks of data includes a respective sequence number, and wherein a first block of data of the plurality of blocks of data includes an initial sequence number;
transmitting blocks of data from a serving base station of the active set of base stations to the mobile station;
for each block of data successfully received by the mobile station, receiving confirmation from the mobile station that includes a sequence number of the successfully received block of data; and
when the sequence number of a block of data successfully received by the mobile station exceeds the initial sequence number by a threshold value, downloading a next plurality of blocks of data from a central buffer to each of the plurality of distributed buffers resident in the plurality of base stations that define the active set of base stations servicing the mobile station base.

14. The method of claim 13, wherein the central buffer is serviced by a base station controller that services the plurality of base stations.

15. The method of claim 13, wherein the central buffer is serviced by a services gateway switching node that services the plurality of base stations.

16. The method of claim 13, wherein only one base station of the active set of base stations may be the serving base station at any particular time.

17. The method of claim 13, wherein:
the mobile station reports the sequence number of a successfully received block of data to the serving base station; and
determining that the sequence number of a block of data successfully received by the mobile station exceeds the initial sequence number by a threshold value is determined by the serving base station.

18. A base station controller comprising:
a packet data serving node interface;
at least one base station interface that interfaces the base station controller to a plurality of base stations; and
at least one digital processor coupled to the Radio Frequency unit that executes software instructions causing the base station controller to:
determine an active set of base stations for servicing the mobile station;
download a plurality of blocks of data to each base station of the active set of base stations, wherein each block of data of the plurality of blocks of data includes a respective sequence number, and wherein a first block of data of the plurality of blocks of data includes an initial sequence number;
receive an indication from a serving base station of the active set of base stations that a data refresh is required; and
download a next plurality of blocks of data to each base station of the active set of base stations.

19. The base station controller of claim 18, wherein only one base station of the active set of base stations services forward link transmissions to the mobile station at any particular time.

20. The base station controller of claim 18, wherein the base station controller supports the 1×EV-DO standard.
